(19) United States
(12) Patent Application Publication
(10) Pub. No.: US 2011/0183208 A1
(43) Pub. Date: Jul. 28, 2011

(54) NEGATIVE-ELECTRODE ACTIVE MATERIAL FOR NONAQUEOUS ELECTROLYTE SECONDARY BATTERY, AND NEGATIVE ELECTRODE AND NONAQUEOUS ELECTROLYTE SECONDARY BATTERY USING THE SAME

(75) Inventors: Takashi OHTSUKA, Osaka (JP); Sumihito Ishida, Osaka (JP); Hiroaki Matsuda, Osaka (JP)

(73) Assignee: PANASONIC CORPORATION, Osaka (JP)

(21) Appl. No.: 13/079,276

(22) Filed: Apr. 4, 2011

Related U.S. Application Data
(62) Division of application No. 11/703,210, filed on Feb. 7, 2007.

(30) Foreign Application Priority Data
Feb. 7, 2006 (JP) 2006-029373

(51) Int. Cl. H01M 4/58; B05D 5/12

(52) U.S. Cl. 429/218.1; 427/78

(57) ABSTRACT

A negative-electrode active material for nonaqueous electrolyte secondary battery, comprising a silicon compound capable of inserting and extracting lithium ion, wherein the silicon compound contains silicon-hydrogen bonds and the silicon-hydrogen bonds are introduced into the compound by reduction of at least one compound selected from the group consisting of silicon oxide, silicon nitride and silicon carbide with hydrogen, and a negative electrode for nonaqueous electrolyte secondary battery having a layer containing the negative-electrode active material in the above arrangement formed on a current collector.

### BACKGROUND OF THE INVENTION

1. Field of the Invention

The present invention relates to a nonaqueous electrolyte secondary battery such as a lithium-ion secondary battery and in particular to improvement of a negative electrode and a negative-electrode active material thereof.

2. Description of the Related Art

Lithium-ion secondary batteries used as the power source for portable electronic devices are currently mainstream products of nonaqueous electrolyte secondary batteries. Recently along with progress of portable devices such as PC and cellphone, there exists a need for a nonaqueous electrolyte secondary battery higher in energy density in the market. For the purpose of satisfying the demand, a negative-electrode active material having a higher capacity density is under study. In particular, lithium metal and materials forming an alloy with lithium are studied intensively from various aspects as a negative-electrode active material having a higher theoretical capacity density. Among the materials forming an alloy with lithium, silicon (Si) is attracting attention as a material having a theoretically high energy density.

However, when silicon is used as a negative-electrode active material and thus subjected to repeated expansions and contractions along with doping and dedoping of lithium ion, silicon particle is known to be broken into smaller particles and results in deterioration in current-collecting efficiency and drastic deterioration in cycle characteristics.

Thus, for prevention of cracking of the particles, there has been studied formation of silicon nanoparticle, formation of silicon composite with a carbon material, formation of silicon alloy with a transition metal, and others. Use of such a material leads to improvement in cycle characteristics compared to a material containing simply only silicon. However, most of the materials are still far below the practical level.

Under such a circumstance, for example, Japanese Patent No. 2997741 proposes to use an oxide of silicon, i.e., a compound containing silicon and oxygen, as the negative-electrode active material. The silicon oxide, which is reported to improve cycle characteristics significantly, is already commercialized in part of coin batteries.

Japanese Unexamined Patent Publication No. Hei 11-102705 proposes to use a nitride of silicon oxide, i.e., a compound containing silicon, oxygen and nitrogen, as the negative-electrode active material, and Japanese Patent No. 3060077 proposes a compound containing silicon and carbon, or a compound containing silicon, carbon and oxygen obtained by heat-treatment of an organic silicon compound as the negative-electrode active material.

As proposed in these prior arts, it is possible to improve cycle characteristics not by using silicon only, but by using a compound obtained by oxidation, nitridation, or carbonization of silicon, as the negative-electrode active material. However, use of the compound as the negative-electrode active material causes a problem that discharge capacity declines significantly from its theoretical capacity. Among silicon and the compounds thereof, the capacity usable as a battery is largest with pure silicon, and the capacity decreases, as silicon is converted to oxide, nitride, or carbide in a greater amount. As a result, decrease in the silicon content in the negative-electrode active material leads to electrochemical inactivation and makes it impossible to use as the negative-electrode active material for nonaqueous electrolyte secondary battery.

### SUMMARY OF THE INVENTION

In view of the above problems residing in the prior arts, an object of the present invention is to provide a negative-electrode active material for nonaqueous electrolyte secondary battery superior in cycle characteristics and higher in energy density.

According to an aspect of the present invention, a negative-electrode active material for nonaqueous electrolyte secondary battery comprises a silicon compound capable of inserting and extracting lithium ion. The silicon compound contains silicon-hydrogen bonds and the silicon-hydrogen bonds are introduced into the compound by reduction of at least one compound selected from the group consisting of silicon oxide, silicon nitride and silicon carbide with hydrogen.

These and other objects, features, aspects, and advantages of the present invention will become more apparent upon reading the following detailed description.

### DETAILED DESCRIPTION OF THE PREFERRED EMBODIMENTS

The negative-electrode active material for nonaqueous electrolyte secondary battery in the present embodiment contains a silicon compound capable of inserting and extracting lithium ion, and the silicon compound has silicon-hydrogen bonds which are introduced into the compound by reduction of at least one compound selected from the group consisting of silicon oxide, silicon nitride and silicon carbide with hydrogen.

In the embodiment, the silicon oxide, silicon nitride or silicon carbide is a precursor compound used for introducing silicon-hydrogen bonds into the compound.

Examples of the silicon oxides include compounds containing Si and O, which are represented by the general formula SiOₓ. Among the compounds, although SiO₂ having an x value of 2 (silicon dioxide) is most stable, silicon oxide of 0<x<2 inserts and extracts lithium ion in a greater amount and thus has a greater charge/discharge capacity. However, even if x is in the range above, the cycle characteristics may decrease drastically when x is less than 0.05, and the discharge capacity becomes significantly lower when it is more than 1.95. Thus, among the silicon oxides represented by SiOₓ, those having the x value of 0.05<x<1.95, which show favorable lithium charge/discharge characteristics, are preferable as the silicon oxide of the present embodiment. Examples of the silicon oxides include SiO_{0.5}, SiO, SiO_{1.33}, SiO_{1.5} and the like.

The silicon oxide SiOₓ particle is prepared, for example, by generating a SiOₓ gas by heating Si or a mixture with SiO₂ as a starting material at a high temperature of 1,000° C. or higher under reduced pressure and then by cooling and solidifying the gas. The method easily gives silicon oxide particle particularly of x=ca. 1. SiOₓ particles produced by other conventional methods are also used favorably without problem.

Examples of the silicon nitrides include compounds containing Si and N as well as compounds containing Si, O, and N. Among them, the silicon nitride in the present embodiment is preferably a compound containing Si, O, and N, from the viewpoint of reactivity in the reduction with hydrogen for introducing silicon-hydrogen bonds into the silicon nitride. The particle of Si₂ N₂O, an example of the silicon nitride, is prepared, for example, by heat-treating a mixture of Si and SiO₂ under nitrogen stream.

Examples of the silicon carbides include compounds containing Si and C, compounds containing Si, O and C, and compounds containing Si, O, N and C. Among them, the silicon carbide in the present embodiment is preferably a compound containing Si, O and C or a compound containing Si, O, N and C, from the viewpoint of reactivity in the reduction with hydrogen for introducing silicon-hydrogen bonds into the silicon carbide. For example, the particle of a compound containing Si, O and C is prepared, for example, by heat-treating a polysiloxane having an organic group on the side chain under inert atmosphere.

The precursor compound for introduction of silicon-hydrogen bonds may be at least one compound selected from the group consisting of silicon oxide, silicon nitride and silicon carbide. These compounds may be used alone or in combination. Alternatively, a solid solution of silicon oxide, silicon nitride or silicon carbide may be used as the precursor compound.

The silicon compound in the present embodiment has silicon-hydrogen bonds introduced by reduction of the precursor compound with hydrogen.

The silicon-hydrogen bond in the silicon compound is preferably at least one bond selected from the bonds represented by Si—H and H—Si—H. The precursor compound, silicon oxide, silicon nitride and silicon carbide, is considered to have a three-dimensional structure respectively formed by mutual bonding of Si with O, N and C. By reduction of the precursor compound in such a structure with hydrogen, part of the bonds in the precursor compound seems to be replaced with silicon-hydrogen bonds. Studies by the inventors have revealed that reduction of the precursor compound with hydrogen gives a silicon compound having at least Si—H or H—Si—H bond and that it enables to improve discharge capacity and cycle characteristics. Apparently, the silicon-hydrogen bonds introduced into the three-dimensional structure increase the number of lithium doping and dedoping sites and consequently the discharge capacity, and suppress local expansion and contraction caused by lithium doping and dedoping, which consequently improves the cycle characteristics.

The Si—H bond in the silicon compound can be identified by appearance of the absorption peak corresponding to Si—H bond at a wavenumber in the range of 2,024 cm⁻¹ to 2,286 cm⁻¹ in infrared absorption (IR) spectrum analysis. Alternatively, the H—Si—H bond can be identified by appearance of the absorption peak corresponding to H—Si—H bond at a wavenumber in the range of 2,095 cm⁻¹ to 2,223 cm⁻¹. Thus, the silicon compound in the present embodiment is preferably a silicon compound having at least one of these IR absorption peaks. The wavenumber of these absorption peaks are numerical values determined by data analysis, and in actual measurement, the absorption peaks are observed as they are slightly shifted by the wavenumber due to measurement error.

In the present embodiment, the silicon compound having silicon-hydrogen bonds is prepared by reduction of its precursor compound with hydrogen.

The hydrogen for the reduction is preferably supplied directly as hydrogen gas. The hydrogen reduction with hydrogen gas is performed, for example, in the following manner: The precursor compound is first placed in an oven under inert atmosphere, and the atmospheric temperature is raised. The inert atmospheric gas is, for example, an inert gas such as argon, helium, or nitrogen. The oven may be left under atmospheric pressure or pressurized. Hydrogen gas is introduced therein after the internal oven temperature is raised to a temperature in the range of 300° C. to 900° C. The partial pressure of hydrogen gas may be set to any partial pressure in the range of approximately 5% to 100%. The compound is left in contact with the hydrogen gas for about 15 minutes and then allowed to cool to normal temperature. The silicon compound in the present embodiment is prepared in such a hydrogen reduction treatment.

The hydrogen for the reduction is also favorably supplied as plasma hydrogen. Hydrogen reduction with plasma hydrogen is performed, for example, by the following hydrogen plasma treatment. A cell containing particles of the precursor compound is placed in a chamber kept under vacuum at approximately 10⁻³ Torr. RF plasma at 100 W is generated under the atmosphere containing argon gas and hydrogen gas. The cell temperature in this step is adjusted to 300° C. The precursor compound can be reduced with hydrogen by using the plasma hydrogen thus generated.

The silicon compound in the present embodiment is used as a negative-electrode active material for nonaqueous electrolyte secondary battery, and the silicon compound as a negative-electrode active material is mixed with a carbon material as a conductive substance, to give a negative-electrode mixture. In such a case, the silicon compound in the present embodiment may be just mixed with the carbon material, but preferably composited with the carbon material. The carbon material to be composited with the silicon compound is preferably carbon nanofiber. In particular, the silicon compound in the present embodiment is preferably composited with the carbon nanofiber directly binding to a surface of the silicon compound, and more preferably, the carbon nanofiber is composited as directly grown on the surface of the silicon compound. A negative-electrode active material showing high-capacity causes great volume change by doping and dedoping of lithium. When the carbon nanofiber is only mixed with the negative-electrode active material, the carbon nanofiber bonded via a binder is easily separated by the volume change, causing deterioration in charge/discharge cycle and current-collecting efficiency. For that reason, the carbon nanofiber is preferably bound directly to the surface of the negative-electrode active material.

An example of the means of binding the carbon nanofiber directly to the surface of the silicon compound as the negative-electrode active material is to place a catalyst on the surface of the precursor compound, grow carbon nanofibers directly from the position of the catalyst by thermal CVD or plasma CVD, and perform hydrogen reduction treatment as well.

The growth of the carbon nanofiber on the surface of the silicon compound by thermal CVD is performed, for example, in the following manner: Placement of silicon oxide containing a catalyst element at least in the surface region in a high-temperature atmosphere containing a raw gas for carbon nanofiber leads to growth of carbon nanofiber. For example, silicon oxide carrying nickel nitrate is placed in a quartz reaction container; heated to a high temperature of 100 to 1,000° C., preferably 400 to 700° C., in an inert or reductive gas; and then, a raw gas for carbon nanofiber is fed into the reaction container. No or only a small amount of carbon nanofiber grows at a reaction-container temperature of lower than 100° C., which leads to deterioration in productivity. Alternatively, decomposition of the reaction gas is accelerated and the carbon nanofiber is produced in a smaller amount at a reaction-container temperature of higher than 1,000° C.

The raw gases for carbon nanofiber for use is, for example, a gas containing a carbon source such as methane, ethane, ethylene, butane, acetylene, or carbon monooxide. The gas supplied is preferably a mixture of the carbon-containing gas and hydrogen gas. Thus, it is possible to carry out growth of carbon nanofiber and hydrogen reduction at the same time. The blending ratio of the carbon-containing gas to the hydrogen gas is preferably 0.2:0.8 to 0.8:0.2 as molar ratio (by volume). When the catalyst element in the metal state is not exposed on the surface of the silicon compound as the negative-electrode active material, it is possible to carry out reduction of the catalyst element and growth of the carbon nanofiber simultaneously by increasing the rate of the hydrogen gas. The carbon nanofiber may incorporate the catalyst element inside during growth. Alternatively, the catalyst element may be present at the interface of the silicon compound particle and the carbon nanofiber.

In the present embodiment, the negative electrode for nonaqueous electrolyte secondary battery is prepared by forming a negative-electrode mixture layer containing the silicon compound as the negative-electrode active material on a current collector. The negative-electrode mixture layer can be formed by preparing a negative-electrode mixture paste by mixing the silicon compound as the negative-electrode active material, a conductive substance, and a binder, and additionally a thickener and others as needed in a solvent, coating the mixture paste on the current collector, drying, and rolling.

The average particle diameter of the silicon compound as the negative-electrode active material is not particularly limited. The average diameter is preferably 3 to 100 μm, more preferably 8 to 20 μm, to facilitate preparation of the negative-electrode mixture paste and the negative electrode therewith.

The conductive substance is, for example, a carbon material such as carbon black, fine particulate graphite, fibrous graphite, or carbon nanofiber. The silicon compound as the negative-electrode active material may be mixed with the carbon material, but is preferably composited with the carbon material, more preferably with the carbon nanofiber, as described above. The length of the carbon nanofiber is preferably 1 nm to 1 mm, more preferably 100 nm to 50 μm, although it depends on the particle diameter of the silicon compound copresent in the negative-electrode mixture paste. A carbon-nanofiber length of shorter than 1 nm leads to significant reduction in effect of increasing conductivity of negative electrode, while a fiber length of longer than 1 mm leads to deterioration in active-material density and capacity of the negative electrode. The diameter of the carbon nanofiber is preferably 1 nm to 1,000 nm and more preferably 20 nm to 200 nm. Carbon nanofibers different in fiber diameter or length may be used as they are mixed.

The amount of the carbon nanofiber as the conductive substance is preferably 5 to 70 parts by mass, with respect to 100 parts by mass of the silicon compound as the negative-electrode active material. A carbon nanofiber content of less than 5 parts by mass may prohibit sufficient improvement in the conductivity of negative electrode and the charge/discharge characteristics and cycle characteristics of battery. The amount of the carbon nanofiber may be increased from the viewpoints of the conductivity of electrode and the charge/discharge characteristics and cycle characteristics of battery, but an amount of more than 70 parts by mass may lead to deterioration in active-material density and capacity of the negative-electrode.

Conventional substances may be used as the binder and the thickener. Examples of the binders include polyvinylidene fluoride (PVDF), styrene-butadiene copolymers (SBR), and the like, and examples of the thickeners include carboxymethylcellulose (CMC) and the like. Examples of the solvents for preparation of the negative-electrode mixture paste include N-methyl-2-pyrrolidone (NMP) and others. The negative electrode for nonaqueous electrolyte secondary battery in the present embodiment can be prepared by preparing a negative-electrode mixture paste by mixing the constituent materials in a solvent, coating the mixture paste on a copper current collector, for example, having a thickness of 10 to 50 μm, drying, rolling and then cutting a resulting film.

Alternatively, the negative electrode for nonaqueous electrolyte secondary battery in the present embodiment can be prepared by forming a thin film containing the silicon compound as the negative-electrode active material directly on a current collector by vapor deposition.

Examples of the method for use in forming the thin film containing the silicon compound directly on a current collector by vapor deposition include EB vapor deposition, sputtering, and CVD. In the EB vapor deposition, a cell containing particles of the silicon compound is placed in a chamber kept under vacuum at approximately 10⁻⁶ Torr. Then, the silicon compound particle in the cell is vaporized as it is heated by irradiation of EB by using an EB gun, and the silicon compound is deposited on the current collector placed in the same vacuum chamber, forming the thin film.

In the embodiment, although it is possible to prepare first the silicon compound as the negative-electrode active material by reduction of the precursor compound such as silicon oxide with hydrogen and then the negative electrode by using the same, as described above, the negative electrode may be prepared alternatively by forming first a mixture layer or thin film containing the precursor compound on the current collector and then reducing the layer or film with hydrogen.

Yet alternatively, it is possible to prepare the negative electrode having the layer containing the silicon compound as the negative-electrode active material formed on the current collector, by forming the precursor compound-containing thin film on the current collector and by simultaneously treating the thin film with hydrogen. In this manner, it is possible to raise the operational efficiency and productivity in preparing the negative electrode in the present embodiment.

In preparing the negative electrode by forming the precursor compound-containing thin film on the current collector and simultaneously treating the thin film with hydrogen, the hydrogen for hydrogen treatment is preferably supplied as hydrogen gas or plasma hydrogen.

In the method of reducing directly with hydrogen gas, thin film formation and hydrogen introduction into the thin film are carried out simultaneously, as hydrogen is supplied as a reactive gas. For example, hydrogen is introduced into the vacuum chamber at a flow rate of 200 sccm, and the particles containing the precursor compound are vaporized under vacuum at approximately 10⁻³ Torr. By adjusting the temperature of the current collector to 400° C. in this step, it is possible to form the thin film containing the silicon compound on the current collector.

An example of the method of forming the thin film and reducing the film with hydrogen by introduction of plasma hydrogen is sputtering. It is possible to introduce hydrogen into the precursor compound-containing thin film formed on the current collector, by using a target of the precursor compound and by discharging in a mixed gas of argon and hydrogen as the sputtering gas. Similarly to the vapor deposition above, by adjusting the current collector temperature to approximately 300° C. or more, it is possible to reliably introduce hydrogen into the thin film and consequently form the thin film containing the silicon compound on the current collector.

The nonaqueous electrolyte secondary battery in the present embodiment can be prepared by opposing the negative electrode for nonaqueous electrolyte secondary battery prepared as described above and a positive electrode to each other via a separator, winding or laminating the electrodes with the separator therebetween to form an electrode assembly, and enclosing the electrode assembly with a nonaqueous electrolyte in a battery case.

The positive electrode can be prepared, for example, by coating a positive electrode mixture paste containing a positive-electrode active material such as lithium oxide and a binder, and additionally a thickener, a conductive substance and others as needed in a solvent on a current collector such as aluminum foil to a particular thickness, drying, rolling, and then cutting. Examples of the separator include microporous films of polyolefin resin. Examples of the nonaqueous electrolytes include liquid electrolytes containing a lithium salt such as LiPF₆ as a solute and a carbonate ester such as ethylene carbonate as a nonaqueous solvent, and gel or solid electrolyte of polyethyleneoxide containing a lithium salt, and the like.

Although the present invention has been described in terms of the presently favorable embodiments, such embodiments are illustrative in all aspects and are not to be interpreted as restrictive. It is to be construed that an unlimited number of modifications not described above are embodied without departing from the scope of the present invention.

### EXAMPLES

Hereinafter, the present invention will be described more specifically with reference to Examples, but it should be understood that the present invention is not limited by these Examples.

### Example 1

Particles of silicon oxide manufactured by Kojundo Chemical Laboratory Co., Ltd. (SiOₓ: x=1) pulverized to a particle diameter of 1 to 10 μm were placed in a quartz reaction container and heated to 550° C. in the presence of helium gas. Then, the helium gas was replaced with a mixed gas of 25 vol % hydrogen gas and 75 vol % carbon monooxide gas, and the particles were subjected to hydrogen reduction treatment at 550° C. for 15 minutes.

IR measurement of the particle of the silicon compound obtained after the hydrogen reduction treatment showed absorption peaks corresponding to νSi—H at 2271 cm⁻¹ and 2220 cm⁻¹.

100 parts by mass of the silicon compound particles obtained by the hydrogen reduction treatment and 30 parts by mass of fine particulate graphite (KS6) as a conductive substance were dry-mixed, to give a composite negative-electrode active material. The composite negative-electrode active material and a binder containing vinylidene fluoride resin were mixed in N-methyl-2-pyrrolidone (NMP), to give a mixture slurry; the slurry was coated on a Cu foil to a thickness of 15 μm; the mixture after drying was rolled; and the film was cut to a piece, to give an negative electrode plate of 3 cm×3 cm. The density of the mixture in the negative electrode plate was 0.8 to 1.4 g/cm³.

After the negative electrode plate was dried sufficiently in an oven at 80° C., a laminate lithium ion battery regulated by a working electrode was prepared by using the negative electrode as the working electrode and a lithium metal foil as a counter electrode. A mixed solution of ethylene carbonate (EC) and diethyl carbonate (DEC) at a volume ratio of 1:1 containing LiPF₆ at a concentration of 1.0 M was used as the nonaqueous electrolyte. A nonaqueous electrolyte secondary battery A was prepared by using #3401 separator manufactured by Celgard as the separator.

### Example 2

A cell containing silicon oxide (SiOₓ: x=1) was placed in a chamber under vacuum at 10⁻³ Torr; RF plasma at 100 W was generated under a mixed gas of argon and hydrogen; and the cell was treated with hydrogen plasma, while the cell temperature was kept at 300° C. for 15 minutes.

IR measurement of the particle of the silicon compound obtained after hydrogen plasma treatment showed absorption peaks corresponding to νSi—H at 2271 cm⁻¹ and 2220 cm⁻¹. A nonaqueous electrolyte secondary battery B was prepared in a similar manner to Example 1, except that the silicon compound particles obtained after the hydrogen plasma treatment were used.

### Example 3

One g of nickel nitrate hexahydrate (analytical grade) manufactured by Kanto Kagaku was dissolved in 100 g of ion-exchange water, and the solution obtained was mixed with silicon oxide (SiOₓ: x=1) pulverized to a diameter of 10 μm or less. The mixture was stirred for one hour; the water therein was removed using an evaporator, to give silicon oxide particles carrying nickel nitrate on the surface.

The silicon oxide particles obtained were placed in a quartz reaction container and heated to 550° C. in the presence of helium gas. The helium gas was then replaced with a mixed gas of 25 vol % hydrogen gas and 75 vol % carbon monooxide gas, and the particles were subjected to hydrogen reduction treatment at 550° C. for one hour, allowing growth of carbon nanofiber on the surface of the silicon compound.

IR measurement of the particle of the silicon compound obtained after hydrogen reduction treatment with simultaneous growth of carbon nanofiber showed absorption peaks corresponding to νSi—H at 2271 cm⁻¹ and 2220 cm⁻¹.

The carbon nanofiber grown had a fiber diameter of 80 nm and a fiber length of 10 to 20 p.m. Then, the mixed gas was replaced with helium gas, and the particles were cooled to room temperature, to give a composite negative-electrode active material for nonaqueous electrolyte secondary-battery. The amount of the carbon nanofiber grown was approximately 30 parts by mass, with respect to 100 parts by mass of the silicon compound particles. The mass of the carbon nanofiber was determined by the change in mass of the silicon oxide particles before and after the growth. A nonaqueous electrolyte secondary battery C was prepared in a similar manner to Example 1, except that the composite negative-electrode active material thus obtained was used.

### Example 4

A cell containing silicon oxide aggregates (SiOₓ: x=1) was placed in a vacuum chamber, and hydrogen was supplied therein at a rate of 200 sccm. The SiOₓ particles in the cell were heated and vaporized by irradiation of EB by using an EB gun under vacuum at approximately 10⁻³ Torr and allowed to deposit on a copper substrate kept at 400° C. which was placed in the same vacuum chamber, forming a silicon compound film reduced with hydrogen on the copper substrate.

IR analysis of the silicon compound film obtained by hydrogen reduction treatment showed absorption peaks corresponding to νSi—H at 2271 cm⁻¹ and 2220 cm⁻¹.

A nonaqueous electrolyte secondary battery D was prepared in a similar manner to Example 1, except that the silicon compound film obtained after the hydrogen reduction treatment was used.

### Example 5

A silicon oxide (SiOₓ: x=1) target was discharged, by using a mixed gas of 75 vol % argon and 25 vol % hydrogen as the sputtering gas. A hydrogen plasma-treated silicon compound film was formed on a copper substrate by keeping the temperature of the copper substrate at 300° C.

IR analysis of the silicon compound film obtained after the hydrogen plasma treatment showed absorption peaks corresponding to νSi—H at 2271 cm⁻¹ and 2220 cm⁻¹.

A nonaqueous electrolyte secondary battery E was prepared in a similar manner to Example 1, except that the silicon compound film obtained after the hydrogen plasma treatment was used.

### Comparative Example 1

A nonaqueous electrolyte secondary battery F was prepared in a similar manner to Example 1, except that a composite negative-electrode active material obtained by dry-blending 30 parts by mass of fine particulate graphite (KS6) as the conductive substance and 100 parts by mass of silicon oxide particles (SiOₓ: x=1) pulverized to a particle diameter of 1 to 10 μm was used.

IR analysis of the silicon oxide particle used showed no absorption peaks corresponding to νSi—H at 2271 cm⁻¹ and 2220 cm⁻¹.

### Comparative Example 2

A cell containing silicon oxide aggregates (SiOₓ: x=1) was placed in a vacuum chamber, and the silicon oxide in the cell was heated and vaporized by irradiation of EB by using an EB gun under vacuum at approximately 10⁻⁶ Torr and allowed to deposit on a copper substrate kept at 400° C. which was placed in the same vacuum chamber, forming a silicon oxide film on the copper substrate. A nonaqueous electrolyte secondary battery G was prepared in a similar manner to Example 1, except that the silicon oxide film obtained was used.

IR analysis of the silicon oxide film obtained after EB vapor deposition showed no absorption peaks corresponding to νSi—H at 2271 cm⁻¹ and 2220 cm⁻¹.

(Evaluation of Battery Characteristics)

Each of the laminate lithium ion batteries prepared in Examples 1 to 5 and Comparative Examples 1 to 2 was charged at an hour rate of 0.2 (0.2 C) with respect to the rated capacity in an environment at 25° C., and then the initial discharge capacity per silicon compound was determined at a discharge rate of 0.2 C.

In addition, the rate (by percentage) of the discharge capacity after repeated charge and discharge for 200 cycles at a charge/discharge rate of 0.2 C relative to the initial discharge capacity obtained at the same charge/discharge rate in an environment at 25° C. was determined as the cycle efficiency.

The results of the initial discharge capacity per silicon compound and the cycle efficiency are summarized in Table 1.

TABLE 1

| | | | | | Initial | |
|---|---|---|---|---|---|---|
| | | | | | discharge | |
| | | | | | capacity | |
| | | | | Silicon | per | |
| | | | Hydrogen | com- | silicon | Cycle |
| | | | reduction | pound | compound | efficiency |
| | | Battery | treatment | used | (mAh/g) | (%) |
| Example | 1 | A | Hydrogen | Particle | 1798 | 75 |
| | | | gas | | | |
| | 2 | B | Plasma | Particle | 1802 | 76 |
| | | | hydrogen | | | |
| | 3 | C | Hydrogen | Particle | 1799 | 86 |
| | | | gas | (Surface | | |
| | | | | treated) | | |
| | 4 | D | Hydrogen | Film | 1800 | 88 |
| | | | gas | | | |
| | 5 | E | Plasma | Film | 1805 | 87 |
| | | | hydrogen | | | |
| Comparative | 1 | F | None | Particle | 1407 | 74 |
| Example | 2 | G | None | Film | 1415 | 85 |

As shown in Table 1, the silicon compounds having silicon-hydrogen bonds introduced by hydrogen reduction of silicon oxide (SiO) in Examples 1 to 5 could increase the discharge capacity by 25% or more compared to the silicon oxides without hydrogen treatment in Comparative Examples 1 and 2. The effect correlates well with the presence of the absorption peaks corresponding to Si—H bond in IR measurement, indicating that the silicon compound enables to provide greater discharge capacity by introducing Si—H bonds into the silicon oxide. As for the mechanism, the number of the lithium sites present in the SiOₓ seems to be increased by introduction of Si—H bonds.

The results show that it is possible to increase the amount of Li doped and dedoped by converting the precursor compound such as silicon oxide into the silicon compound having silicon-hydrogen bonds by hydrogen reduction.

Further, silicon oxide having very low electron conductivity should be blended with a conductive substance, when used as particles. In such a case, a conductive substance such as carbon material or metal may simply be added, but as shown in Example 3, by binding carbon nanofiber directly onto the surface of the silicon compound containing silicon-hydrogen bonds, it is possible to make the cycle efficiency better than that of the silicon compound without surface treatment in Examples 1 to 2. It seems that direct binding of the carbon nanofiber resulted in prevention of the breakdown of the conductive network caused by expansion and contraction of the silicon compound during the charge/discharge cycle and consequently improvement in the cycle efficiency.

As described above, an aspect of the invention is directed to a negative-electrode active material for nonaqueous electrolyte secondary battery, comprising a silicon compound capable of inserting and extracting lithium ion, wherein the silicon compound contains silicon-hydrogen bonds and the silicon-hydrogen bonds are introduced into the compound by reduction of at least one compound selected from the group consisting of silicon oxide, silicon nitride and silicon carbide with hydrogen.

In the above arrangement, the silicon compound as the negative-electrode active material having the silicon-hydrogen bonds introduced by hydrogen reduction of its precursor compound has a greater number of sites inserting and extracting lithium ion, and thus, achieves a greater charge/discharge capacity.

The silicon oxide as the precursor compound is preferably a silicon oxide represented by SiOₓ (wherein, 0.05<x<1.95).

The silicon compound obtained by hydrogen reduction of SiOₓ shows lithium charge/discharge characteristics favorable as the negative-electrode active material.

The silicon-hydrogen bond in the silicon compound is preferably at least one bond selected from Si—H and H—Si—H.

These silicon-hydrogen bonds increase the amount of lithium doped and dedoped, and consequently, the discharge capacity.

The hydrogen for hydrogen reduction is preferably supplied as hydrogen gas or plasma hydrogen.

The hydrogen gas or plasma hydrogen makes it possible to introduce the silicon-hydrogen bonds into the precursor compound by hydrogen reduction more easily and reliably.

Further, the silicon compound as the negative-electrode active material preferably has carbon nanofiber grown on the surface.

By binding the carbon nanofiber as a conductive substance directly onto the surface of the silicon compound, it is possible to prevent local expansion and contraction caused by lithium doping and dedoping and consequently improve the cycle characteristics.

It is also possible to prepare a negative electrode for nonaqueous electrolyte secondary battery having greater charge/discharge capacity and improved cycle characteristics, by forming a layer containing the negative-electrode active material for nonaqueous electrolyte secondary battery in the configuration above on a current collector.

In preparing the negative electrode for nonaqueous electrolyte secondary battery by forming the layer containing the negative-electrode active material in the configuration above on the current collector, it is preferable to form a layer containing at least one compound selected from the group consisting of silicon oxide, silicon nitride and silicon carbide on the current collector and simultaneously to treat the layer with hydrogen.

In the above arrangement, it is possible to raise the productivity in producing the negative electrode for nonaqueous electrolyte secondary battery, by conducting operations of forming the layer containing the precursor compound on the current collector and treating the layer with hydrogen at the same time.

The hydrogen for hydrogen treatment is preferably supplied as hydrogen gas or plasma hydrogen.

By using the hydrogen gas or plasma hydrogen, it is possible to introduce hydrogen easily and reliably into the layer formed on the current collector.

It is also possible to prepare a nonaqueous electrolyte secondary battery higher in energy density and superior in reliability by using the negative electrode for nonaqueous electrolyte secondary battery in the configuration above, a positive electrode, and a nonaqueous electrolyte.

Thus, the present invention provides the negative-electrode active material for nonaqueous electrolyte secondary battery superior in cycle characteristics and higher in energy density and also the nonaqueous electrolyte secondary battery higher in capacity and reliability by using the same.

This application is based on Japanese Patent Application No. 2006-029373 filed on Feb. 7, 2006, the contents of which are hereby incorporated by reference.

1-11. (canceled)

12. A method for producing a negative-electrode for a nonaqueous electrolyte secondary battery, the method comprising steps of:
forming a layer containing negative-electrode active material which comprises a silicon compound capable of inserting and extracting lithium ion on the current collector, and
simultaneously treating the layer with hydrogen, wherein:
the silicon compound contains silicon-hydrogen bonds, and
the silicon-hydrogen bonds are introduced into the compound by reduction of at least one compound selected from the group consisting of silicon oxide, silicon nitride and silicon carbide with hydrogen.

13. The method for producing the negative-electrode according to claim 12, wherein the hydrogen for treatment is supplied as hydrogen gas.

14. The method for producing the negative-electrode according to claim 12, wherein the hydrogen for treatment is supplied as plasma hydrogen.

15. The method for producing the negative-electrode according to claim 12, wherein the silicon oxide is represented by SiOₓ, where 0.05<x<1.95.

16. The method for producing the negative-electrode according to claim 12, wherein the silicon-hydrogen bond is at least one bond selected from the bonds represented by Si—H and H—Si—H.

17. A nonaqueous electrolyte secondary battery, comprising the negative electrode produced by the method according to claim 12, a positive electrode, and a nonaqueous electrolyte.
